(19) United States
(12) Patent Application Publication
(10) Pub. No.: US 2023/0059476 A1
(43) Pub. Date: Feb. 23, 2023

(54) DISCRIMINATION APPARATUS, METHOD AND LEARNING APPARATUS

(71) Applicant: KABUSHIKI KAISHA TOSHIBA, Tokyo (JP)

(72) Inventors: Pengju GAO, Yokohama Kanagawa (JP); Tomohiro YAMASAKI, Tokyo (JP); Yasutoyo TAKEYAMA, Kawasaki Kanagawa (JP)

(73) Assignee: KABUSHIKI KAISHA TOSHIBA, Tokyo (JP)

(21) Appl. No.: 17/674,295

(22) Filed: Feb. 17, 2022

(30) Foreign Application Priority Data
Aug. 18, 2021 (JP) 2021-133394

(51) Int. Cl. G06F 40/279; G06F 40/166

(52) U.S. Cl. CPC G06F 40/279; G06F 40/166

(57) ABSTRACT

According to one embodiment, a discrimination apparatus includes a processor. The processor acquires an event indicative of a case that is a processing object, and a document including a plurality of sentences. The processor generates a plurality of subsets in each of which part of the sentences are grouped. The processor discriminates, in regard to each of the subsets, a causal relationship between a sentence included in the subset and the event.

### CROSS-REFERENCE TO RELATED APPLICATIONS

This application is based upon and claims the benefit of priority from Japanese Patent Application No. 2021-133394, filed Aug. 18, 2021, the entire contents of which are incorporated herein by reference.

### FIELD

Embodiments described herein relate to a discrimination apparatus, method and a learning apparatus.

### BACKGROUND

In a document analysis in natural language processing, if a causal relationship between a case and a sentence in a document can be discriminated, a more efficient information collection can be realized. However, in general, only one causal relationship can be extracted in regard to one context, and it is difficult to discriminate a plurality of causal relationships. In addition, since there is a constraint on the length of a document that is an object, there is such a problem that a feature quantity, such as a similarity to a distant sentence in a document, cannot be extracted, and it is difficult to understand a context between distant sentences in a document.

### BRIEF DESCRIPTION OF THE DRAWINGS

FIG. 1 is a block diagram illustrating a discrimination apparatus according to a first embodiment.

FIG. 2 is a flowchart illustrating an operation of the discrimination apparatus according to the first embodiment.

FIG. 3 is a view illustrating an example of a subset generation process of a subset generator.

FIG. 4 is a view illustrating an example of discrimination results of a causal relationship discrimination unit.

FIG. 5 is a view illustrating a determination example of a causal relationship.

FIG. 6 is a view illustrating a determination example of a causal relationship in a case where values with low certainty are excluded.

FIG. 7 is a view illustrating an example in which results of statistical processes are combined.

FIG. 8 is a block diagram illustrating a learning apparatus according to a second embodiment.

FIG. 9 is a view illustrating a generation example of training data according to the second embodiment.

FIG. 10 is a view illustrating an example of a model configuration of a causal relationship discrimination unit according to the second embodiment.

FIG. 11 is a flowchart illustrating an operation of the learning apparatus according to the second embodiment.

FIG. 12 is a view illustrating a hardware configuration of the discrimination apparatus and learning apparatus according to the embodiments.

### DETAILED DESCRIPTION

In general, according to one embodiment, a discrimination apparatus includes a processor. The processor acquires an event indicative of a case that is a processing object, and a document including a plurality of sentences. The processor generates a plurality of subsets in each of which part of the sentences are grouped. The processor discriminates, in regard to each of the subsets, a causal relationship between a sentence included in the subset and the event.

Hereinafter, a discrimination apparatus, method and a learning apparatus according to embodiments will be described in detail with reference to the accompanying drawings. Note that in the embodiments below, parts denoted by identical reference signs are assumed to perform similar operations, and an overlapping description is omitted unless where necessary.

### First Embodiment

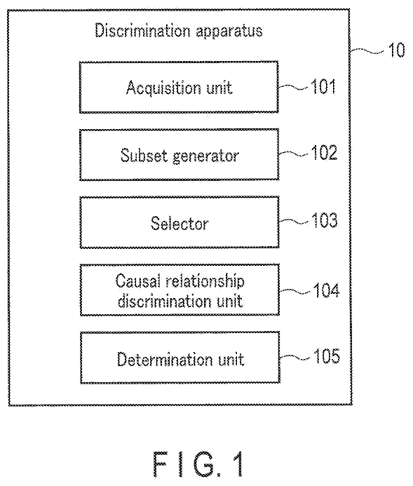

A discrimination apparatus according to a first embodiment will be described with reference to a block diagram of FIG. 1.

A discrimination apparatus 10 according to the first embodiment includes an acquisition unit 101, a subset generator 102, a selector 103, a causal relationship discrimination unit 104, and a determination unit 105.

The acquisition unit 101 acquires an event indicative of a case that is a processing object, and a document including a plurality of sentences. The event according to the present embodiment is, for example, a character string indicative of a cause or a result, and is used in order to extract a sentence from the document as a sentence having a causal relationship. For example, if the event is a character string indicative of a result, such as “water leaked”, a character string indicative of a cause, such as “because of a crack occurring in a piping”, from the document. Conversely, the event may be a character string indicative of a cause, such as “because of a crack occurring in a piping”, and, in this case, the objective of the event is the extraction of a character string indicative of a result, such as “water leaked”, from the document.

In addition, the event may be a character string indicative of a question or an answer. For example, if the event is a character string indicative of a question, such as “where is the station?”, the objective of the event is the extraction of a character string indicative of an answer, such as “about 200 m to the right”, from the document. Conversely, if the event is a character string indicative of an answer, such as “about 200 m to the right”, the objective of the event is the extraction of a character string indicative of a question, such as “where is the station?”. In this manner, the event is not limited to a character string relating to a causal relationship, and it suffices that the event is a character string indicative of one of a pair of related elements such as a question and an answer.

The subset generator 102 generates a plurality of subsets in each of which part of a plurality of sentences are grouped.

The selector 103 selects a target that is a sentence (also referred to as a target sentence), which becomes a discrimination object of a causal relationship, in each of the subsets.

The causal relationship discrimination unit 104 discriminates, in regard to each subset, a causal relationship between sentences included in the subset and the event.

The determination unit 105 determines a causal relationship between the event and the entirety of the document, based on the causal relationship discriminated in regard to each subset.

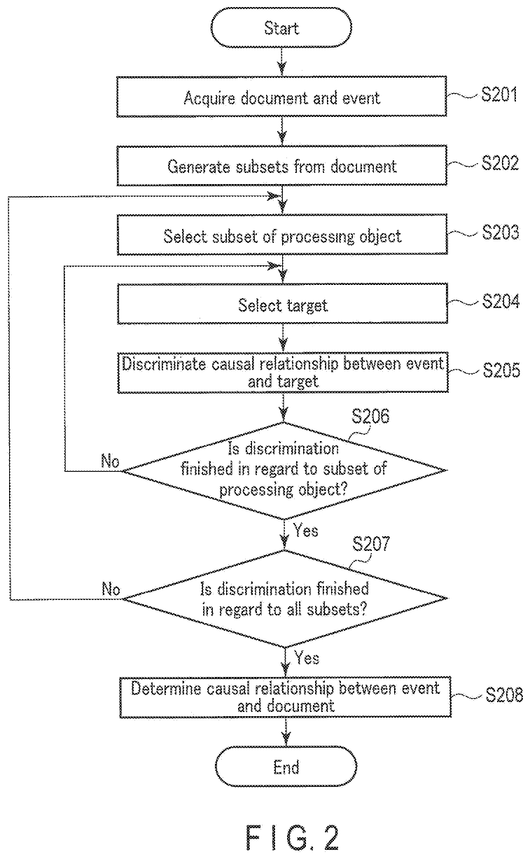

Next, an operation of the discrimination apparatus 10 according to the first embodiment will be described with reference to a flowchart of FIG. 2.

In step S201, the acquisition unit 101 acquires a document and an event from the outside.

In step S202, using a plurality of sentences included in the acquired document, the subset generator 102 generates a plurality of subsets by grouping part of the sentences. In the generation of the subset, for example, a sentence having a low relevance to the acquired event is excluded, and sentences having a relevance of a threshold or more to the input event are selected from the document and are grouped. As regards the relevance, for example, a similarity of information between the event and each sentence may be analyzed. In addition, the similarity is indicative of a degree of similarity between the event and the sentence. As the content of the event is closer to the content of the sentence, the similarity is higher. Thus, a sentence having a similarity of a threshold or more is determined to be a sentence having a relevance of a threshold or more. In addition, as the relevance, use may be made of an information quantity that is analyzed from the character string of the event and the content of each sentence. For example, the information quantity of each sentence is analyzed from a meaning or an occurrence frequency of a word group that constitutes the sentence. A sentence, which has a greater information quantity, includes unique information, compared to other sentences.

In step S203, the selector 103 selects a subset of a processing object from the subsets.

In step S204, the selector 103 selects a target that is a comparison object with the event, from a plurality of sentences included in the subset of the processing object.

In step S205, the causal relationship discrimination unit 104 discriminates whether a causal relationship is present between the event and the target, for example, by sing a trained model. The trained model is, for example, a model to which the event and the target are input, and which outputs a value of a discrimination result of the causal relationship. As the trained mode, for example, a trained model of machine learning, which will be described later in a second embodiment, is assumed. Note that, aside from the trained model, any method, which can extract a causal relationship between the event and the target, may be used.

In step S206, the causal relationship discrimination unit 104 determines whether the causal relationship has been discriminated in regard to all sentences included in the subset of the processing object. If the causal relationship has been discriminated in regard to all sentences, the process advances to step S207. If a sentence that is yet to be processed is present, the process returns to step S204, and the above-described process is repeated for the sentence that is yet to be processed.

In step S207, the causal relationship discrimination unit 104 determines whether the causal relationship has been discriminated in regard to all subsets generated in step S202. If the causal relationship has been discriminated in regard to all subsets, the process advances to step S208. If a subset that is yet to be processed is present, the process returns to step S203, and the above-described process is repeated for the subset that is yet to be processed.

In step S208, the determination unit 105 determines, from the discrimination results for the respective subsets, the causal relationship between the event and the entirety of the document. As regards the causal relationship between the event and the entirety of the document, the determination unit 105 may calculate a certainty corresponding to the discrimination result of the causal relationship for each target, and may determine a target with a highest certainty as the causal relationship between the event and the entirety of the document. In addition, voting may be executed in regard to values corresponding to a plurality of kinds of discrimination results, and a target with a large number of votes indicative of the determination of the presence of that the causal relationship may be determined as the causal relationship between the event and the entirety of the document.

By the above, the discrimination process of the discrimination apparatus 10 is finished. Note that in the description of step S203 to step S207, an example is described in which the causal relationship is discriminated on a subset-by-subset basis. Aside from this, the causal relationships between the event and the targets may be discriminated in parallel in regard to a plurality of subsets. Specifically, the selector 103 may select targets in regard to the subsets, and the causal relationship discrimination unit 104 may successively determine the causal relationships in regard to the targets selected in the respective subsets.

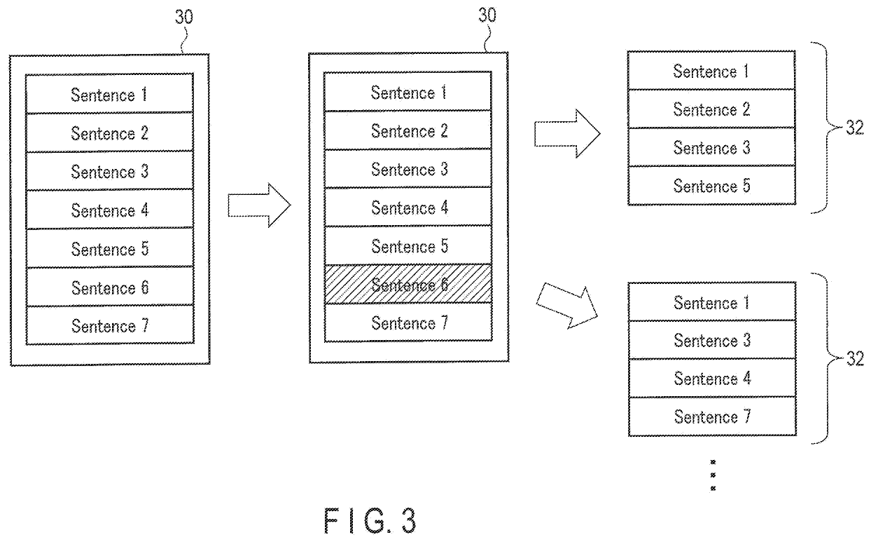

Next, referring to FIG. 3, a description will be given of a subset generation process of the subset generator according to the first embodiment.

FIG. 3 illustrates an example of a document 30 and a plurality of subsets 32 generated from the document 30.

A case is assumed in which the document 30 includes seven sentences (sentence 1 to sentence 7) in the order of occurrence in the document 30. It is assumed that the lengths (e.g. the numbers of characters) of the sentences selected as the subset are substantially equal, but the lengths may be different between the sentences. In addition, it is assumed that the number of sentences included in one subset is equal between the subsets, but may be different between the subsets.

In the example of FIG. 3, it is assumed that six sentences, namely the sentence 1 to sentence 5 and the sentence 7, which have relevances of a threshold or more, are extracted, and the sentence 7 is excluded as a sentence that has a relevance of less than the threshold and may become noise.

The subset generator 102 selects and groups, from the six sentences, namely the sentence 1 to sentence 5 and the sentence 7, four sentences multiple times at random, and generates a plurality of subsets 32. Specifically, for example, “sentence 1, sentence 2, sentence 3 and sentence 5” are selected as a first subset 32, and “sentence 1, sentence 3, sentence 4 and sentence 7” are selected as a second subset 32. In addition, the subset generator 102 generates the subsets such that at least one sentence in the document is overlappingly included in a plurality of subsets. Specifically, in the example of FIG. 3, “sentence 1 and sentence 3” are included in both of the two subsets 32.

In this manner, the subsets 32 can be generated up to a number of combinations, _{N}C_{M}, where the number of sentences included in the document is N (N is a natural number of 3 or more) and the number of sentences included in the subset is M (M is a natural number of 2 or more, and less than N). Specifically, in the example of FIG. 3, ₆C₄=15 kinds of subsets 32 can be generated. Since the sentences having a relevance are grouped in each subset 32, contexts of a plurality of patterns can be generated.

Note that when the lengths of the sentences included in the document 30 are not uniform, the lengths of the sentences may be processed to become uniform in the generation process of the subsets 32. For example, assuming that the sentence 1 is composed of 60 characters and the sentence 2 is composed of 120 characters, when the number of characters of the character string of the sentence is a threshold (here, 60 characters, for instance) or more, the sentence may be divided at a position of a comma corresponding to substantially the same length as the threshold of 60 characters, and the divided sentences may be used. For example, in the sentence 2, if a comma occurs at the 55th character, the sentence 2 is divided at the position of the comma, and a sentence 2-1 (55 characters) and a sentence 2-2 (65 characters) may be generated and used for the generation of the subset 32.

Besides, when a certain sentence is set as a reference, a subset may be generated by taking into account a balance between a sentence whose position of occurrence in the document is close to the certain sentence and a sentence whose position of occurrence in the document is distant from the certain sentence. Specifically, when the sentence 1 is set as a reference in the generation of a certain subset 32 and the sentence 2 is selected, not the sentence 3 but the sentence 7 is selected. As regards the criterion for the selection, for example, sentences included in the subset 32 may be selected such that the total of the distances of the sentences from the sentence 1 becomes a threshold or more.

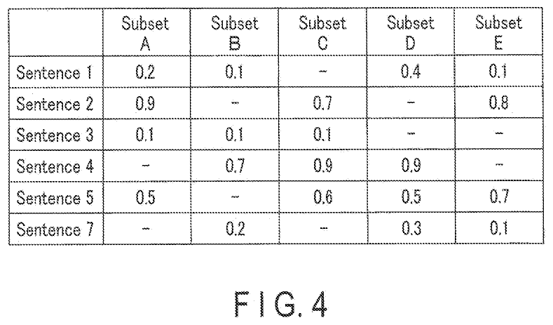

Next, FIG. 4 illustrates an example of discrimination results of the causal relationship discrimination unit 104.

FIG. 4 is a table illustrating discrimination results of causal relationships of four sentences included in each of five subsets, namely a subset A to a subset E. The four sentences are a combination of four of six sentences (sentence 1 to sentence 5, and sentence 7). In the illustrated example, numerical values from 0 (zero) to 1 are allocated as discrimination results. A value closer to 0 indicates that the causal relationship between the event and the sentence is more likely to be absent, and a value closer to 1 indicates that the causal relationship between the event and the sentence is more likely to be present.

Note that a sign “-”, which is indicative of no relevance, is input to the field of a sentence that is not included in the subset.

For example, in the subset A, the value of the sentence 2 is “0.9”, and the value of the sentence 5 is “0.5”. In this manner, the causal relationship discrimination unit 104 discriminates the causal relationships in regard to all sentences included in each of the subsets.

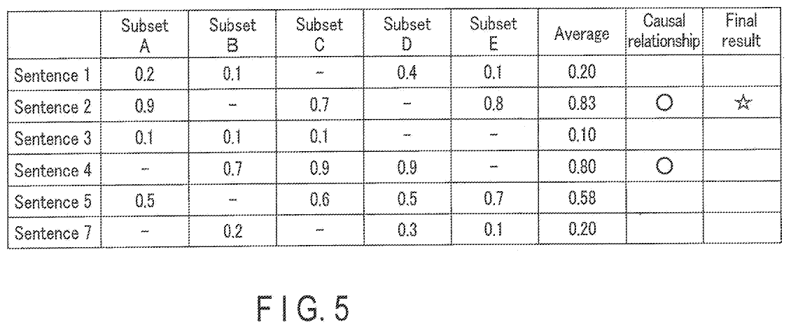

Next, FIG. 5 illustrates a determination example of a causal relationship in the determination unit 105.

FIG. 5 is a table in which an item indicative of an average value, an item indicative of the presence/absence of a causal relationship, and an item of a final result indicative of a causal relationship between the event and the entirety of the document are added to the table illustrated in FIG. 4.

In FIG. 5, the determination unit 105 calculates an average value of values indicative of the discrimination results of sentences included in a plurality of subsets. The determination unit 105 compares the average value and a threshold. Here, “0.7” is set as the threshold for the average value of the discrimination results. The determination unit 105 determines the “presence of causal relationship” if the average value is equal to or greater than the threshold, and determines the “absence of causal relationship” if the average value is less than the threshold. In addition, the determination unit 105 may output, as the final result of the causal relationship of the entirety of the document to the event, the sentence with the maximum average value among the sentences that are determined to have the causal relationships.

In the example of FIG. 5, the “presence of causal relationship” is determined for the “sentence 2 and sentence 4”, and the “absence of causal relationship” is determined for the “sentence 1, sentence 3, sentence 5 and sentence 7”. In addition, the “sentence 2” with a highest average value is determined as the final result of the causal relationship of the document to the event. Note that, aside from the average value, use may be made of a statistical value by other statistical processing, such as a median, a maximum value, a minimum value, a mode, or a deviation value.

In addition, the presence/absence of the causal relationship may be determined by such voting that “0.3” or less is counted as the absence of the causal relationship, and “0.7” or more is counted as the presence of the causal relationship. For example, assume that the discrimination results of the sentence 5 are “0.6, 0.7, 0.9, 0.7, 0.2”, the vote for the absence of causal relationship is one (0.2), and the vote for the presence of causal relationship is three (0.7, 0.9, 0.7), and thus the presence of causal relationship can be determined by the voting.

Furthermore, in the first embodiment, since it is assumed that the output from the causal relationship discrimination unit 104 is the output from the trained model and is expressed in the range of “0˜1”, it can be said that a value, which is closer to 0 or 1, is indicative of a higher certainty with respect to the causal relationship. However, in the case of an intermediate value such as “0.4˜0.6”, it can be said that the discrimination of the presence/absence of causal relationship is difficult, and the certainty is low. Thus, the causal relationship of the entirety of the document may be determined by using values excluding a value with a low certainty.

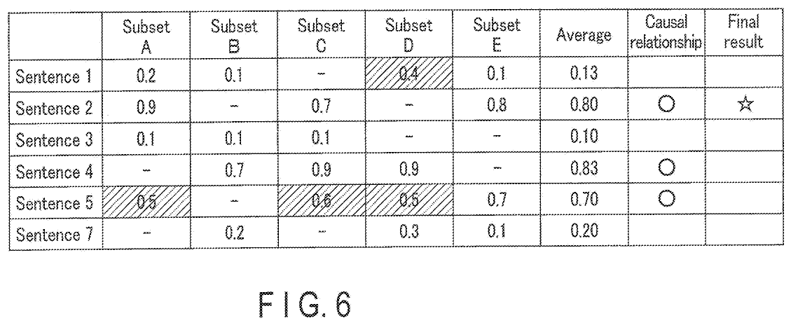

FIG. 6 illustrates a determination example of a causal relationship in the case where a value with a low certainty is excluded.

The determination unit 105 may execute a decision by majority in regard to the presence/absence of discrimination results, for example, by voting, by excluding values of “0.4˜0.6” from the values of the discrimination results, and using only values of “0.0˜0.3” and “0.7˜1.0”. FIG. 6, compared to the table of FIG. 5, indicates that values of “0.4˜0.6” are marked by hatching and excluded from the calculation.

In the above-described FIG. 5, since the average value of the “sentence 5” is less than the threshold, the absence of the causal relationship is determined. However, in the example of FIG. 6, since the average value of the “sentence 5” is “0.7” and is equal to or greater than the threshold, the presence of the causal relationship is determined.

In this manner, by determining the final result of the causal relationship, based on the values with high certainty, the precision of the extraction of the causal relationship can be enhanced by using the values with high certainty, while excluding ambiguous discrimination results by the model of the causal relationship discrimination unit.

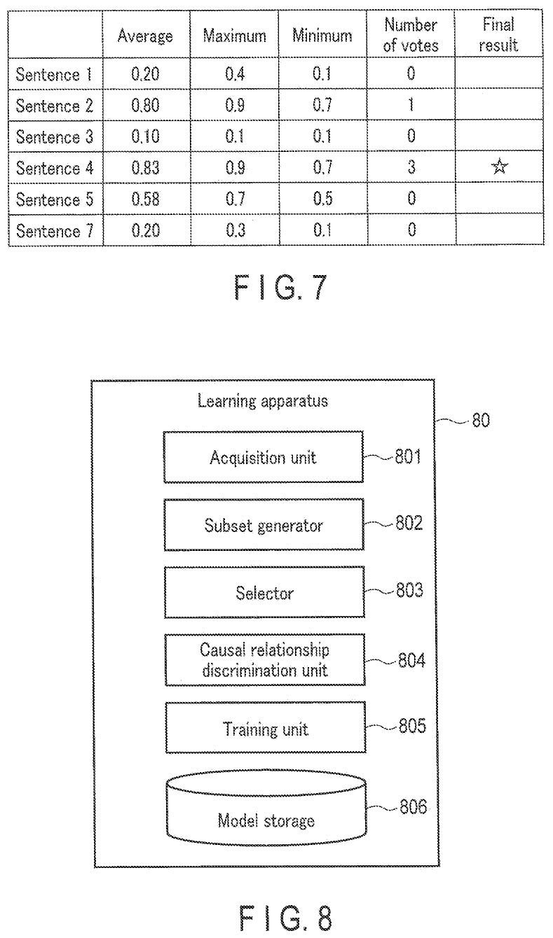

Besides, the determination unit 105 may determination the causal relationship between the event and the entirety of the document, by combining results of a plurality of statistical processes. FIG. 7 illustrates an example in which results of statistical processes are combined.

FIG. 7 is a table in which statistical values that are results of statistical processes are input in regard to each of the sentence 1 to 5 and the sentence 7.

The table illustrated in FIG. 7 indicates items of an average value, a maximum value, a minimum value and the number of votes. For example, a sentence with a maximum number of times, by which the sentence takes the highest value in each item, may be adopted as a final result of the causal relationship. For example, the “sentence 4” is in the first rank in the items of the average value (0.82), maximum value (0.9) and number of votes (3), and the number of times by which the “sentence 4” takes the highest value is three. On the other hand, the “sentence 2” is in the first rank in the maximum value (0.9), and the number of times by which the “sentence 2” takes the highest value is one. Thus, the determination unit 105 can determine, as the final result, that the sentence of the causal relationship between the event and the entirety of the document is the “sentence 4”.

According to the above-described first embodiment, part of a plurality of sentences included in one document are combined to generate a plurality of subsets each of which includes a plurality of sentences. A causal relationship between the target and the event is discriminated by using the subsets. Thereby, there is substantially no constraint on the length of data that is a comparison object with the event, and a relationship with a distant sentence in the document can also be discriminated. In addition, since the causal relationship can be discriminated in regard to a plurality of sentences included in the subsets, a plurality of sentences having causal relationships with one event can be extracted.

Furthermore, since the sentences included in each of the subsets have a relevance, contexts of a plurality of patterns can be generated. Thus, since discrimination results of causal relationships, in which contexts of patterns are taken into account, can be obtained in the trained model, the extraction result of the causal relationship with a high certainty can be obtained. In short, high-precision discrimination can be realized.

### Second Embodiment

In the first embodiment, the example is illustrated in which the causal relationship is extracted from a plurality of subsets by using a trained model. However, it is also possible to train the model of the causal relationship discrimination unit by the subsets generated by the subset generator.

A learning apparatus according to a second embodiment will be described with reference to a block diagram of FIG. 8.

A learning apparatus 80 according to the second embodiment includes an acquisition unit 801, a subset generator 802, a selector 803, a causal relationship discrimination unit 804, a training unit 805, and a model storage 806.

The acquisition unit 801 acquires a document including a plurality of sentences, an event, and a label that is given to a sentence having a causal relationship with the event. Specifically, a label that is a correct answer is given to a sentence in the document, which has a causal relationship. Hereinafter, a document including a sentence, to which a label is given, is also referred to as “labeled document”.

Like the first embodiment, the subset generator 802 generates a plurality of subsets from the document.

The selector 803 selects a target in regard to the event, from each of the subsets.

The causal relationship discrimination unit 804 is a network model that is an object of training. The subsets and the event are input to the network model that is the object of training, and the network model outputs a discrimination result of the causal relationship.

The training unit 805 calculates a training loss between the output of the network model and the label that is the correct answer. The training unit 805 updates parameters of the network model in such a manner as to minimize the training loss. If the training by the training unit 805 is completed, a trained model is generated.

The model storage 806 stores the network model before the training, and the trained model after the training. In addition, where necessary, the model storage 806 may store a document or the like for generating training data.

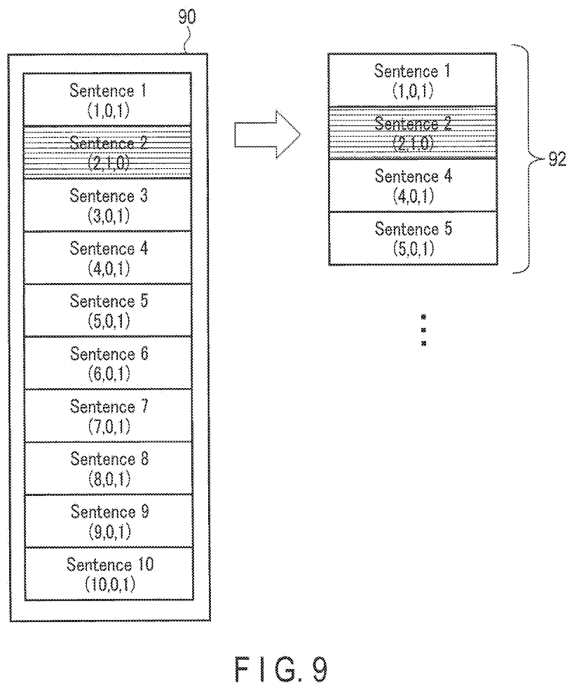

Next, a generation example of training data according to the second embodiment will be described with reference to FIG. 9.

FIG. 9 illustrates an example of the labeled document. In one document 90 including ten sentences, namely a sentence 1 to a sentence 10, a label indicative of the presence of the causal relationship with the event is given to the “sentence 2”. In addition, it is assumed that the subset generator 802 generates a plurality of subsets each including four sentences from the document 90.

In each of the subsets, an index of a target in the subset, and a label indicating whether the target has a causal relationship with the event, are set as training data. A sentence number in the document is allocated to the target. Specifically, the sentence numbers of the “sentence 1” to “sentence 10” of the document 90 are allocated as indices of sentences that are targets. As the label, when a causal relationship is present, i.e. in the case of a positive example, a label (1, 0) is allocated. When a causal relationship is absent, i.e. in the case of a negative example, a label (0, 1) is allocated. Needless to say, a label expressed by one bit may be used, and the case of a positive example may be expressed by “1”, and the case of a negative example may be expressed by “0”. In the document 90, since the sentence 2 is a positive example, a label (1, 0) is allocated to the sentence 2, and, since the sentences other than the sentence 2 are negative examples, labels (0, 1) are allocated to these sentences.

Specifically, in a subset 92 illustrated in FIG. 9, the “sentence 1, sentence 2, sentence 4 and sentence 5” are selected from the document 90. For example, the sentence 1 can be uniquely expressed by (1, 0, 1) by combining the index “1” indicative of the sentence number and the label indicative of the negative example. On the other hand, the sentence 2 can be uniquely expressed by (2, 1, 0) by combining the index “2” indicative of the sentence number and the label indicative of the positive example. The same process may be executed for the sentences included in each of the generated subsets.

In this manner, in regard to each of the subsets, when the sentences are selected as targets, the training data, in which the labels of the positive example and the negative example are added, can be prepared. Thus, compared to the case of using one document 90 as a whole as the training data, an augmentation (data augmentation) of the number of training data can be realized.

Note that when the number of generated training data is large, a deviation in the number of data of positive examples and the number of data of negative examples is not a serious problem. However, when the number of training data is small, if the positive examples and the negative examples are not equal in ratio, there may be a case in which over-learning is executed with a deviation to the positive examples or the negative examples. In such a case, the numbers of labels of positive examples and negative examples may be controlled. For example, in regard to the event, subsets may be generated such that the number of subsets including sentences of positive examples is set at a ratio of 50% to all subsets, the number of subsets including only sentences of negative examples is set at a ratio of 25% to all subsets, and the number of subsets including sentences selected at random is set at a ratio of 25% to all subsets.

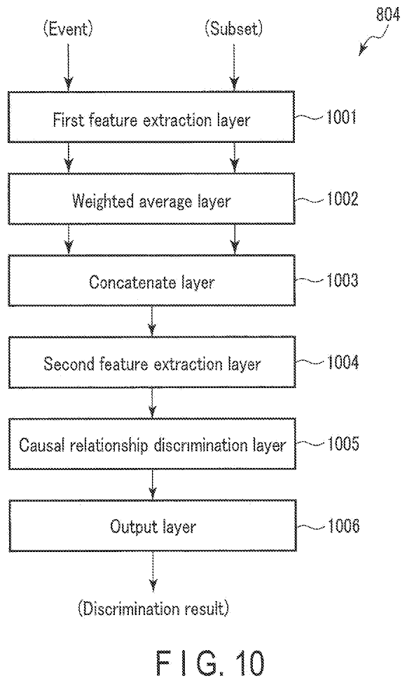

Next, referring to FIG. 10, a description will be given of an example of a model configuration of the causal relationship discrimination unit 804 according to the second embodiment.

FIG. 10 illustrates a network model that is an object of training, the network model implementing the causal relationship discrimination unit 804. The network model includes a first feature extraction layer 1001, a weighted average layer 1002, a concatenate layer 1003, a second feature extraction layer 1004, a causal relationship discrimination layer 1005, and an output layer 1006.

The first feature extraction layer 1001 is a trained language model such as BERT (Bidirectional Encoder Representations from Transformer). An event and a subset, which are training data, are input to the first feature extraction layer 1001. The first feature extraction layer 1001 extracts an event feature quantity from the event, and extracts a subset feature quantity from the subset. Note that, aside from the trained model such as BERT, any process may be applied if the process can extract feature quantities from the event and the subset.

The weighted average layer 1002 receives the event feature quantity and subset feature quantity from the first feature extraction layer 1001, and executes a weighted-averaging process, based on an adjustable parameter that can be set by a task. As regards the output from the weighted average layer 1002, a process of reducing the number of dimensions by one in regard to the input is assumed. Aside from this, the number of dimensions may be further reduced, or may not be reduced.

The concatenate layer 1003 receives the weighted averaged event feature quantity and subset feature quantity from the weighted average layer 1002, and binds the event feature quantity and the subset feature quantity.

The second feature extraction layer 1004 includes, for example, a Dense layer, a Multi_Head_Self_Attention layer, and a Global_Max_Pooling layer. The second feature extraction layer 1004 receives the output from the concatenate layer 1003, analyzes the feature quantity of each word in the sentences of the subset, and the association between words, and executes conversion to a sentence feature quantity that is a feature quantity in units of a sentence. It is assumed that the second feature extraction layer 1004, too, reduces the number of dimensions in regard to the output from the concatenate layer.

The causal relationship discrimination layer 1005 includes, for example, a Position Encoding layer, a Transformer layer, and a Multiply layer. The causal relationship discrimination layer 1005 receives the index of the target included in the training data, and the output from the second feature extraction layer 1004, and outputs a discrimination result of the causal relationship between the event and the target sentence, while referring to sentences near the target.

The output layer 1006 receives the output from the causal relationship discrimination layer 1005, and outputs a numerical value of “0˜1” as a discrimination result, for example, by using a softmax function. Specifically, as the output value is closer to 0, the certainty that the causal relationship is absent is higher. As the output value is closer to 1, the certainty that the causal relationship is present is higher.

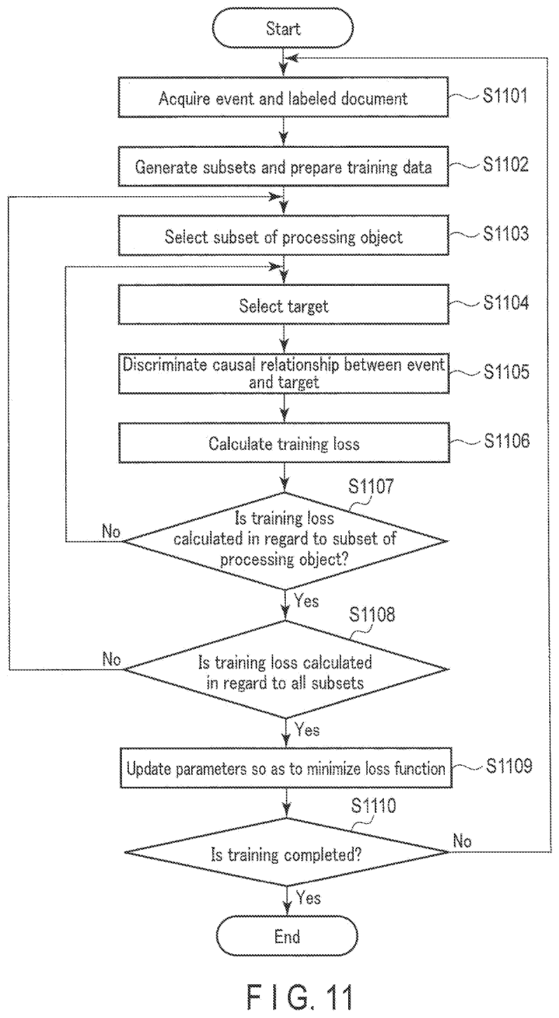

Next, a training process of the learning apparatus 80 according to the second embodiment will be described with reference to a flowchart of FIG. 11.

In step S1101, the acquisition unit 801 acquires an event and a labeled document.

In step S1102, the subset generator 802 generates a plurality of subsets, based on sentences included in the labeled document, thereby generating training data. A description of the subset generation process is omitted, since the same process as in the first embodiment may be executed.

In step S1103, the selector 803 selects a subset of a processing object from the subsets.

In step S1104, the selector 803 selects a target from sentences included in the subset of the processing object.

In step S1105, the causal relationship discrimination unit 804 inputs the event and the subset of the processing object to the network model as illustrated in FIG. 10. The network model outputs a value (here, a value in the range of 0˜-1) which represents the presence/absence of the causal relationship between the target selected in step S1104 and the event.

In step S1106, the training unit 805 sets the label of the target as correct answer data, and calculates a training loss that is a difference between the value that is output from the network model, and the correct answer data.

In step S1107, the training unit 805 determines whether the training loss is calculated in regard to all sentences included in the subset of the processing object. If the training loss is calculated in regard to all sentences, the process advances to step S1108. If there remains a sentence that is yet to be processed, the process returns to step S1104, and a similar process is repeated for the sentence that is yet to be processed. In step S1108, the training unit 805 determines whether the training loss is calculated in regard to all subsets generated in step S1102. If the training loss is calculated in regard to all subsets, the process advances to step S1109. If the training loss is not calculated in regard to all subsets, the process returns to step S1103, and a similar process is repeated for the subset that is yet to be processed.

In step S1109, the training unit 805 updates parameters of the network model in such a manner as to minimize an loss function in which training loss are collected, the loss function being obtained by a statistic process such as averaging of calculated training loss relating to targets. For example, the training unit 805 may update parameters, such as a weighting factor and a bias, in regard to the network model, by using an error backpropagation method, a stochastic gradient decent method, and the like.

In step S1110, the training unit 805 determines whether the training is completed. For example, when a determination index, such as an output value or a decrease value of an loss function, has decreased to a threshold or less, the training unit 805 may determine that the training is completed, or, when the number of times of training, for example, the number of times of update of parameters, has reached a predetermined number of times, the training unit 805 may determine that the training is completed. When the training is completed, the training process ends, and, as a result, the trained model is generated which is utilized in the causal relationship discrimination process of the causal relationship discrimination unit 104 according to the first embodiment.

On the other hand, when the training is not completed, the process returns to step S1101, and a similar process is repeated. Note that the training method of the training unit 805, which is illustrated in step S1106 to step S1110, is not limited to the above, and a general training method may be used.

According to the above-described second embodiment, a plurality of subsets are generated from one labeled document in which a correct answer label is added to a sentence having a causal relationship with the event. Thereby, each of the subsets can be used for training data as a labeled document, and a data augmentation of training data can be realized.

Furthermore, by training the network model by using the data-augmented training data, a trained model, which can execute the causal relationship extraction with higher precision, can be generated.

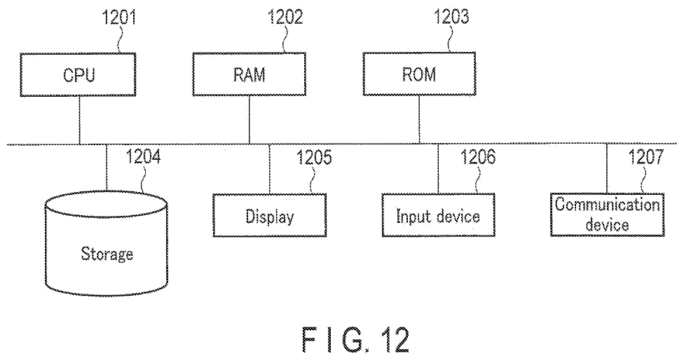

Here, an example of a hardware configuration of the discrimination apparatus 10 and learning apparatus 80 according to the above embodiments is illustrated in a block diagram of FIG. 12.

Each of the discrimination apparatus 10 and learning apparatus 80 includes a CPU (Central Processing Unit) 1201, a RAM (Random Access Memory) 1202, a ROM (Read Only Memory) 1203, a storage 1204, a display 1205, an input device 1206 and a communication device 1207, and these components are connected by a bus.

The CPU 1201 is a processor which executes an arithmetic process and a control process, or the like, according to programs. The CPU 1201 uses a predetermined area of the RAM 1202 as a working area, and executes processes of the respective components of the above-described discrimination apparatus 10 and learning apparatus 80 in cooperation with programs stored in the ROM 1203 and storage 1204, or the like.

The RAM 1202 is a memory such as an SDRAM (Synchronous Dynamic Random Access Memory). The RAM 1202 functions as the working area of the CPU 1201. The ROM 1203 is a memory which stores programs and various information in a non-rewritable manner.

The storage 1204 is a device which writes and reads data to and from a magnetic recording medium such as an HDD (Hard Disc Drive), a semiconductor storage medium such as a flash memory, a magnetically recordable storage medium such as an HDD, an optically recordable storage medium, or the like. The storage 1204 writes and reads data to and from the storage medium in accordance with control from the CPU 1201.

The display 1205 is a display such as an LCD (Liquid Crystal Display). The display 1205 displays various information, based on a display signal from the CPU 1201.

The input device 1206 is an input device such as a mouse and a keyboard, or the like. The input device 1206 accepts, as an instruction signal, information which is input by a user's operation, and outputs the instruction signal to the CPU 1201.

The communication device 1207 communicates, via a network, with an external device in accordance with control from the CPU 1201.

The instructions indicated in the processing procedures illustrated in the above embodiments can be executed based on a program that is software. A general-purpose computer system may prestore this program, and may read in the program, and thereby the same advantageous effects as by the control operations of the above-described discrimination apparatus and learning apparatus can be obtained. The instructions described in the above embodiments are stored, as a computer-executable program, in a magnetic disc (flexible disc, hard disk, or the like), an optical disc (CD-ROM, CD-R, CD-RW, DVD-ROM, DVD±R, DVD±RW, Blu-ray (trademark) Disc, or the like), a semiconductor memory, or other similar storage media. If the storage medium is readable by a computer or an embedded system, the storage medium may be of any storage form. If the computer reads in the program from this storage medium and causes, based on the program, the CPU to execute the instructions described in the program, the same operation as the control of the discrimination apparatus and learning apparatus of the above-described embodiments can be realized. Needless to say, when the computer obtains or reads in the program, the computer may obtain or read in the program via a network.

Additionally, based on the instructions of the program installed in the computer or embedded system from the storage medium, the OS (operating system) running on the computer, or database management software, or MW (middleware) of a network, or the like, may execute a part of each process for implementing the embodiments.

Additionally, the storage medium in the embodiments is not limited to a medium which is independent from the computer or embedded system, and may include a storage medium which downloads, and stores or temporarily stores, a program which is transmitted through a LAN, the Internet, or the like.

Additionally, the number of storage media is not limited to one. Also when the process in the embodiments is executed from a plurality of storage media, such media are included in the storage medium in the embodiments, and the media may have any configuration.

Note that the computer or embedded system in the embodiments executes the processes in the embodiments, based on the program stored in the storage medium, and may have any configuration, such as an apparatus composed of any one of a personal computer, a microcomputer and the like, or a system in which a plurality of apparatuses are connected via a network.

Additionally, the computer in the embodiments is not limited to a personal computer, and may include an arithmetic processing apparatus included in an information processing apparatus, a microcomputer, and the like, and is a generic term for devices and apparatuses which can implement the functions in the embodiments by programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A discrimination apparatus comprising a processor configured to:
acquire an event indicative of a case that is a processing object, and a document including a plurality of sentences;
generate a plurality of subsets in each of which part of the sentences are grouped; and
discriminate, in regard to each of the subsets, a causal relationship between a sentence included in the subset and the event.

2. The apparatus according to claim 1, wherein the processor generates the subsets, based on a similarity of between the event and each of the sentences included in the document.

3. The apparatus according to claim 1, wherein the processor generates the subsets such that at least one sentence in the document is overlappingly included in a plurality of subsets.

4. The apparatus according to claim 1, wherein the processor is further configured to select a target sentence in each of the subsets,
wherein the processor discriminates a causal relationship between the event and the target sentence.

5. The apparatus according to claim 1, wherein the processor is further configured to determine a causal relationship between the event and an entirety of the document, based on the causal relationship discriminated in regard to each of the subsets.

6. The apparatus according to claim 5, wherein the processor calculates a certainty of the causal relationship discriminated in regard to each of the subsets, and determines, based on the certainty, the causal relationship between the event and the entirety of the document.

7. The apparatus according to claim 5, wherein the processor calculates a plurality of values by a plurality of discrimination means in regard to a causal relationship for each of the subsets, and determines a causal relationship between the event and the entirety of the document by voting relating to the plurality of values.

8. A discrimination method comprising:
acquiring an event indicative of a case that is a processing object, and a document including a plurality of sentences;
generating a plurality of subsets in each of which part of the sentences are grouped; and
discriminating, in regard to each of the subsets, a causal relationship between a sentence included in the subset and the event.

9. The method according to claim 8, wherein the generating generates the subsets, based on a similarity of between the event and each of the sentences included in the document.

10. The method according to claim 8, wherein the generating generates the subsets such that at least one sentence in the document is overlappingly included in a plurality of subsets.

11. The method according to claim 8, further comprising selecting a target sentence in each of the subsets,
wherein the discriminating discriminates a causal relationship between the event and the target sentence.

12. The method according to claim 8, further comprising determining a causal relationship between the event and an entirety of the document, based on the causal relationship discriminated in regard to each of the subsets.

13. The method according to claim 12, further comprising calculating a certainty of the causal relationship discriminated in regard to each of the subsets, and determines, based on the certainty, the causal relationship between the event and the entirety of the document.

14. The method according to claim 12, further comprising calculating a plurality of values by a plurality of discrimination means in regard to a causal relationship for each of the subsets, and determining a causal relationship between the event and the entirety of the document by voting relating to the plurality of values.

15. A learning apparatus comprising a processor configured to:
acquire an event indicative of a case that is a processing object, and a labeled document including a plurality of sentences and a label relating to a sentence having a causal relationship with the event;
generate a plurality of subsets in each of which part of the sentences included in the labeled document are grouped;
output, in regard to each of the subsets, a discrimination result of a causal relationship between a sentence included in the subset and the event, by using a network model; and
generate a trained model by training the network model in such a manner as to minimize an loss function relating to a difference between the discrimination result and the label.
